(19) United States
(12) Patent Application Publication
(10) Pub. No.: US 2011/0278981 A1
(43) Pub. Date: Nov. 17, 2011

(54) ROTOR FOR ELECTRIC ROTATING MACHINE

(75) Inventors: Ryosuke UTAKA, Takahama-shi (JP); Atsuo Ishizuka, Nagoya (JP)

(73) Assignee: DENSO CORPORATION, Kariya-city (JP)

(21) Appl. No.: 13/105,186

(22) Filed: May 11, 2011

(30) Foreign Application Priority Data
May 12, 2010 (JP) 2010-110530

(51) Int. Cl. H02K 1/28

(52) U.S. Cl. 310/216.121

(57) ABSTRACT

A rotor for an electric rotating machine is provided. The rotor includes a shaft and a core which is fastened to an outer periphery surface of the shaft by shrink fitting. The shaft includes a fastening portion to which the core is fastened. A diameter of the fastening portion is smaller than a diameter of at least one other portion of the shaft.

### CROSS-REFERENCE TO RELATED APPLICATION

This application is based on and claims the benefit of priority from earlier Japanese Patent Application No. 2010-110530 filed May 12, 2010, the description of which is incorporated herein by reference.

### BACKGROUND

1. Technical Field

The present invention relates to a rotor for an electric rotating machine which is installed in, for example, a vehicle.

2. Related Art

For example, Japanese Patent No. 3423485 discloses a rotor for an electric rotating machine which is installed in a vehicle. The rotor has a shaft, and a cylindrical core with which the outer periphery surface of the shaft is engaged and fitted by press fitting. In addition, regarding this type of rotor, a technique so-called “shrink fitting” is known which is a method of fastening the core and the shaft to each other. According to this method, a shaft is inserted into a fitting hole of the core in a state where a temperature difference is made between the core and a shaft (temperature of the core>temperature of the shaft). When the temperature difference becomes zero, fastening power is generated between the core and the shaft.

When the core and the shaft are fastened to each other by shrink fitting as described above, the core contracts as the temperature of the heated core is lowered to the temperature of the shaft (room temperature), whereby the inner diameter of the core decreases. In this case, the material (thickness) corresponding to the interference of the inner periphery portion of the core (the difference between the inner diameter of the core and the outer diameter of the shaft) is deformed not only in the radial direction and the circumferential direction but also in the axial direction in which the fitting hole is formed. Hence, part of the material expands in the axial direction. Specifically, when a large interference is set to ensure large fastening power between the core and the shaft, the expansion of the material in the axial direction becomes more remarkable. Accordingly, the expansion of part of the material of the core in the axial direction causes displacement of position of the core in the axial direction with respect to the shaft or a stator, or causes unbalanced rotation of the rotor.

### SUMMARY

An embodiment provides a rotor for an electric rotating machine, which can prevent part of material of a core from expanding in the axial direction when the core and a shaft are fastened to each other by shrink fitting.

As an aspect of the embodiment, a rotor for an electric rotating machine is provided, which includes a shaft and a core which is fastened to an outer periphery surface of the shaft by shrink fitting, wherein the shaft includes a fastening portion to which the core is fastened, and a diameter of the fastening portion is smaller than a diameter of at least one other portion of the shaft.

### BRIEF DESCRIPTION OF THE DRAWINGS

In the accompanying drawings:

FIG. 1 is a cross-sectional view illustrating the general configuration of a vehicle alternator as a vehicular electric rotating machine;

FIG. 2 is a sectional view of a rotor for the electric rotating machine according to the first embodiment, which is cut in the axial direction of the rotor;

FIG. 3 is a sectional view of a shaft according to the first embodiment, which is cut in the axial direction of the shaft;

FIG. 4 is a sectional view of a shaft according to the second embodiment, which is cut in the axial direction of the shaft; and

FIG. 5 is a sectional view of a shaft according to the third embodiment, which is cut in the axial direction of the shaft.

### DETAILED DESCRIPTION OF THE PREFERRED EMBODIMENTS

With reference to the accompanying drawings, hereinafter are described embodiments of a rotor for an electric rotating machine.

### First Embodiment

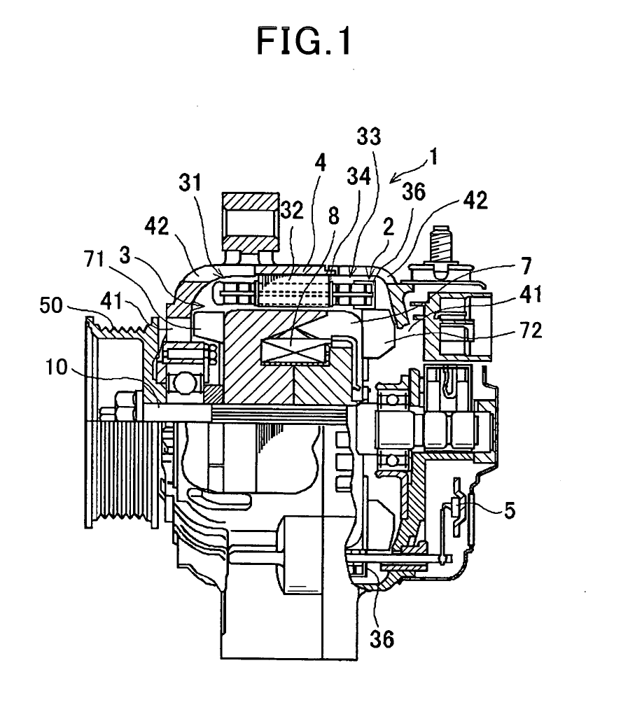

FIG. 1 is a cross-sectional view illustrating the general configuration of a vehicle alternator 1 as a vehicular electric rotating machine, according to the embodiment. As shown in FIG. 1, the vehicle alternator 1 includes a stator 2, a rotor 3, a frame 4 and a rectifier 5. The stator 2 includes a stator core 32, a plurality of conductor segments 33, an insulator 34 and a resin material 36. The plurality of segments 33 configure a stator winding. The insulator 34 electrically insulates between the stator core 32 and the conductor segments 33. The resin material 36 is formed in an annular shape, being imparted with insulation properties, to establish connection between weld portions at the tip ends of the respective conductor segments 33.

The stator core 32 is formed by stacking thin steel plates, with a number of slots being formed in the inner peripheral surface thereof. The conductor segments 33 exposed from the stator core 32 form coil ends 31 of the stator winding. The rotor 3 has a configuration in which pole cores 7 (which configures a core 20 described later) sandwich therebetween a field coil 8 from both sides via a shaft 10. The field coil 8 is formed of a copper wire that has been subjected to insulating treatment and cylindrically and concentrically wound up. The pole cores 7 each have six claw portions.

The pole core 7 on a front side has an end face to which an axial-flow cooling fan 71 is attached by welding or the like. The cooling fan 71 charges cooling air from the front side and axially and radially discharges the cooling air. Similarly, the pole core 7 on a rear side has an end face to which a centrifugal cooling fan 72 is attached by welding or the like. The cooling fan 72 charges cooling air from the rear side and discharges the cooling air in the radial direction.

The frame 4 accommodates the stator 2 and the rotor 3 and supports the rotor 3 so that the core of the rotor 3 is rotatable about the shaft 10. Meanwhile, the stator 2 is fixed to the frame 4 so as to be located on an outer peripheral side of the pole cores 7 of the rotor 3, with a predetermined gap being interposed between the pole cores 7 and the stator 2. The frame 4 is provided with discharge ports 42 at positions facing the respective coil ends 31 of the stator 2 to discharge cooling air, and provided with charge ports 41 at respective axial end faces thereof.

In the vehicle alternator 1 having such a configuration, the core of the rotor 3 rotates in a given direction upon transmission of torque to a pulley 50 from an engine, not shown, via a belt and the like. When excitation voltage is applied in this state from the outside to the field coil 8 of the rotor 3, the claw portions of the pole cores 7 are excited to allow the stator winding to generate three-phase alternating voltage, while a predetermined direct current is taken from an output terminal of the rectifier 5.

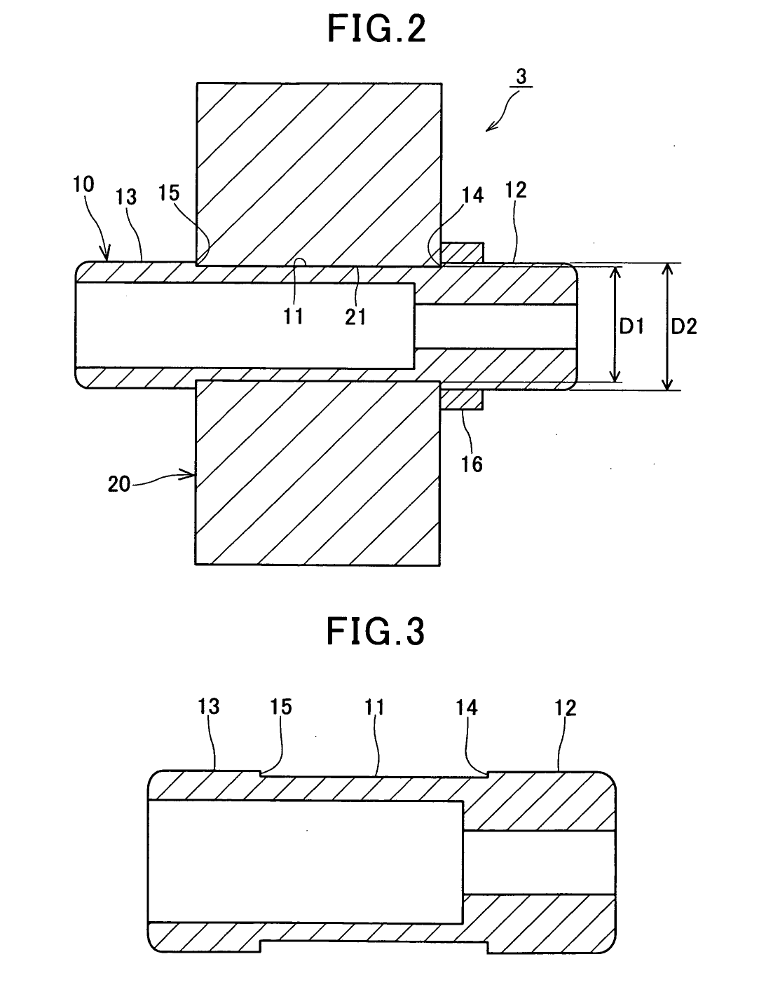

FIG. 2 is a sectional view of the rotor for the vehicle alternator 1, which is an electric rotating machine, according to the first embodiment, which is cut in the axial direction of the rotor. FIG. 3 is a sectional view of the shaft, which is cut in the axial direction of the shaft.

The rotor 3 is used in the electric rotating machine which serves as both a motor and a generator of a vehicle. The rotor 3 is accommodated in a housing (frame 4) of the electric rotating machine and is rotatably disposed at the inner periphery side of the stator 2. As shown in FIG. 2, the rotor 3 includes the shaft 10, the core 20, and a positioning member 16. The core 20 is fastened to the outer periphery surface of the shaft 10 by shrink fitting. The positioning member 16 is engaged and fitted with the outer periphery surface of the shaft 10.

As shown in FIGS. 2 and 3, the shaft 10 is made of iron metal and has a hollow cylindrical shape having a predetermined size. The shaft 10 has a fastening portion 11 at the middle part in the axial direction thereof. The core 20 is fastened to the fastening portion 11. The outer diameter D1 of the fastening portion 11 is smaller than the outer diameters of other portions of the shaft 10 by a predetermined dimension, and is constant in the axial direction of the fastening portion 11. That is, the outer diameter D1 is smaller than outer diameters D2 of one end side portion 12 and the other end side portion 13 which are adjacent to both sides of the fastening portion 11. The outer diameters D2 of one end side portion 12 and the other end side portion 13 are the same. Hence, stepped surfaces 14 and 15 are respectively formed between the fastening portion 11 and the end side portion 12 and between the fastening portion 11 and the end side portion 13. The stepped surfaces 14 and 15 have ring shapes extending in the direction perpendicular to the axial direction of the shaft 10. The positioning member 16 having a ring shape is engaged and fitted with the outer periphery surface of the end of the end side portion 12 at the side of the fastening portion 11 by press fitting. The positioning member 16 is fixed at the position where one end surface in the axial direction of the positioning member 16 is flush with the stepped surface 14.

The core 20 has a cylindrical shape in which a plurality of annular magnetic steel sheets are laminated which have circular through holes at the central portion thereof. The core 20 has a plurality of magnetic poles formed of permanent magnets. The magnetic poles having different polarities are alternately arranged in the circumferential direction. The core 20 has a fitting hole 21 which penetrates the core 20 in the axial direction and fits with the fastening portion 11 of the shaft 10. The diameter of the fitting hole 21 before the core 20 and the shaft 10 are fastened to each other is set so as to be smaller than the outer diameter of the fastening portion 11 by a predetermined dimension. The difference between the diameter of the fitting hole 21 and the outer diameter of the fastening portion 11 is set so as to serve as an interference generated when the core 20 and the shaft 10 are fastened to each other by shrink fitting.

The core 20 and the shaft 10 are fastened to each other by shrink fitting as described below. First, the core 20 is heated to be expanded until the diameter of the fitting hole 21 of the core 20 becomes larger than the outer diameter of the end side portion 13 of the shaft 10. Next, at room temperature, the end side portion 13 of the shaft 10 is inserted into the fitting hole 21 of the expanded core 20. The shaft 10 is pressed into the fitting hole 21 until the shaft 10 reaches the position at which the positioning member 16 contacts the core 20. Hence, the core 2D is positioned at a predetermined position of the periphery side of the fastening portion 11 of the shaft 10. In this state, the core 20 is left.

Then, the heated core 20 contracts as the temperature is lowered to the temperature of the shaft 10 (room temperature), whereby the inner diameter of the core 20 decreases. Since the outer diameter D1 of the fastening portion 11 of the shaft 10 is smaller than the outer diameters D2 of other portions (one end side portion 12 and the other end side portion 13), the material (thickness) corresponding to the interference of the inner periphery portion of the core 20 can be additionally deformed in the radial direction by the difference between the outer diameter D2 and the outer diameter D1 (D2−D1). Hence, when the material (thickness) corresponding to the interference of the core 20 is deformed, the deformation is sufficiently absorbed because the material (thickness) is deformed in the radial direction. Therefore, part of the material (thickness) corresponding to the interference can be prevented from expanding in the axial direction. In addition, since the stepped surfaces 14 and 15 are formed at the both sides in the axial direction of the fastening portion 11, part of the material (thickness) corresponding to the interference can also be prevented from expanding in the axial direction by the stepped surfaces 14 and 15.

According to the rotor of the present embodiment described above, since the outer diameter D1 of the fastening portion 11 of the shaft 10 is smaller than the outer diameters D2 of other portions (one end side portion 12 and the other end side portion 13), part of the material (thickness) corresponding to the interference can be prevented from expanding in the axial direction when the shaft 10 and the core 20 are fastened to each other by shrink fitting.

In addition, by the stepped surfaces 14 and 15 respectively formed between the fastening portion 11 and one end side portion 12 and between the fastening portion 11 and the other end side portion 13, part of the material (thickness) corresponding to the interference can also be prevented from expanding in the axial direction. Hence, the material (thickness) corresponding to the interference can be prevented more reliably from expanding in the axial direction.

In addition, according to the present embodiment, since the outer diameter D1 of the fastening portion 11 is constant in the axial direction, the interference for the core 20 and the shaft 10 can be easily set so as to be uniform in the axial direction.

### Second Embodiment

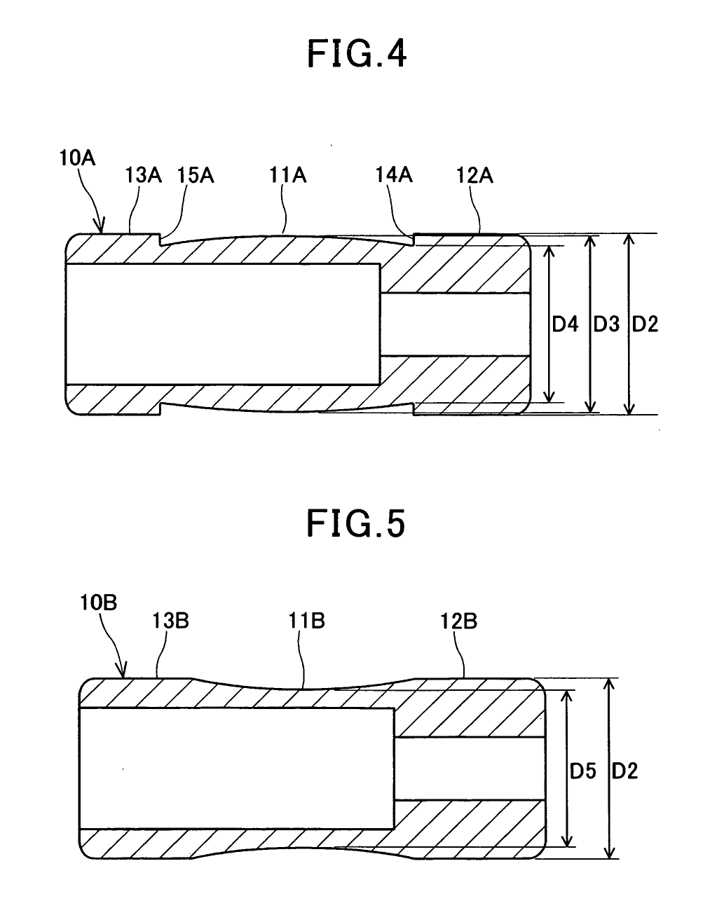

FIG. 4 is a sectional view of a shaft according to the second embodiment, which is cut in the axial direction of the shaft. In the first embodiment, the outer diameter of the fastening portion 11 of the shaft 10 is constant in the axial direction. According to the rotor of the second embodiment, as shown in FIG. 4, the outer diameter of the fastening portion 11A of the shaft 10A gradually decreases in the axial direction of the fastening portion 11A from the middle part to the both ends of the fastening portion 11A. This configuration of the fastening portion differs from that of the first embodiment.

In the present embodiment, the outer diameter D3 (maximum diameter) of the middle part in the axial direction of the fastening portion 11A is slightly smaller than the outer diameters D2 of other portions (one end side portion 12 and the other end side portion 13). The outer diameters D4 (minimum diameter) of the both end portions in the axial direction of the fastening portion 11A are smaller than the outer diameter D3 of the middle part in the axial direction by a predetermined dimension. In addition, stepped surfaces 14A and 15A are respectively formed between the fastening portion 11A and one end side portion 12A and between the fastening portion 11A and the other end side portion 13A, as in the case of the first embodiment.

According to the rotor of the present embodiment described above, since the outer diameters D3 and D4 of the fastening portion 11A are smaller than the outer diameters D2 of other portions, part of the material (thickness) corresponding to the interference can be prevented from expanding in the axial direction when the shaft 10A and the core 20 are fastened to each other by shrink fitting, which is the same advantage as that of the first embodiment.

Specifically, in the present embodiment, since the outer diameter D3 of the middle part in the axial direction of the fastening portion 11A is larger than the outer diameters D4 of the both end portions of the fastening portion 11A, the interference can be set so as to be relatively large at the middle part in the axial direction of the fastening portion 11A so that large fastening power can be obtained.

### Third Embodiment

FIG. 5 is a sectional view of a shaft according to the third embodiment, which is cut in the axial direction of the shaft. In the second embodiment, the outer diameter of the fastening portion 11A of the shaft 10A gradually decreases from the middle part in the axial direction to the both ends. According to the rotor of the third embodiment, as shown in FIG. 5, the outer diameter of the fastening portion 11B of the shaft 10B gradually decreases in the axial direction of the fastening portion 11B from the both ends to the middle part of the fastening portion 11B. This configuration of the fastening portion differs from that of the second embodiment.

In the present embodiment, the outer diameters of the both end portions in the axial direction of the fastening portion 11B gradually decrease in the axial direction of the fastening portion 11B from one end side portion 12B and the other end side portion 13B, which are located at both sides of the fastening portion 11B and have outer diameters D2, to the middle part. The outer diameter D5 (minimum diameter) of the middle part in the axial direction of the fastening portion 11B is smaller than the outer diameters D2 of one end side portion 12B and the other end side portion 13B by a predetermined dimension.

According to the rotor of the present embodiment described above, since the outer diameter D5 of the fastening portion 11B is smaller than the outer diameters D2 of other portions, part of the material (thickness) corresponding to the interference can be prevented from expanding in the axial direction when the shaft 10B and the core 20 are fastened to each other by shrink fitting. Specifically, in the present embodiment, since the fastening portion 11B is formed so that the outer diameter thereof gradually decreases in the axial direction thereof from the both ends to the middle part thereof, the shaft 10B can be easily formed with the fastening portion 11B by a simple method such as grinding.

Note that, although the both sides in the axial direction of the fastening portion 11B of the present embodiment are not formed with the stepped surfaces 14, 14A, 15 and 15A which are formed in the first and second embodiments, the fastening portion 11B may be formed so as to have the stepped surfaces 14, 14A, 15 and 15A. According to this configuration, the material (thickness) corresponding to the interference can be prevented more reliably from expanding in the axial direction.

Hereinafter, aspects of the above-described embodiments will be summarized.

As an aspect of the embodiment, a rotor for an electric rotating machine is provided, which includes a shaft and a core which is fastened to an outer periphery surface of the shaft by shrink fitting, wherein the shaft includes a fastening portion to which the core is fastened, and a diameter of the fastening portion is smaller than a diameter of at least one other portion of the shaft.

According to the rotor, when the core and the shaft are fastened to each other by shrink fitting, the heated core contracts as the temperature of the core is lowered to the temperature of the shaft (room temperature), whereby the inner diameter of the core decreases. According to the rotor, since the diameter of the fastening portion, to which the core is fastened, is smaller than the diameter of the at least one other portion of the shaft, the material corresponding to the interference of the inner periphery portion of the core (the difference between the inner diameter of the core and the outer diameter of the shaft) can be deformed in the radial direction by the difference between the diameter of the fastening portion and the diameter of the at least one other portion. Hence, when the material corresponding to the interference of the core is deformed, the deformation is sufficiently absorbed due to the deformation of the material in the radial direction. Therefore, part of the material corresponding to the interference can be prevented from expanding in the axial direction.

In the rotor, the shaft includes a step between the fastening portion and the at least one other portion.

According to the rotor, when the material corresponding to the interference of the core is deformed, the material can be prevented more reliably from expanding in the axial direction due to the step formed between the fastening portion of the shaft and the at least one other portion of the shaft.

In the rotor according to the first embodiment of the invention, the diameter of the fastening portion is constant in the axial direction of the fastening portion.

According to the rotor, since the diameter of the fastening portion of the shaft is constant in the axial direction, the interference for the core and the shaft can be easily set so as to be uniform in the axial direction of the fastening portion. In addition, since the step is also formed between the fastening portion and the at least one other portion of the shaft, the material corresponding to the interference can be prevented more reliably from expanding in the axial direction.

In the rotor according to the second embodiment of the invention, the diameter of the fastening portion gradually decreases in the axial direction of the fastening portion from a middle part of the fastening portion to both ends of the fastening portion.

According to the rotor, since the diameter of the middle part in the axial direction of the fastening portion is larger than the diameters of the both end portions of the fastening portion, the interference can be set so as to be relatively large at the middle part so that large fastening power can be obtained. Note that, since the step is also formed between the fastening portion and the at least one other portion of the shaft, the material corresponding to the interference can be prevented more reliably from expanding in the axial direction.

In the rotor according to the third embodiment of the invention, the diameter of the fastening portion gradually decreases in the axial direction of the fastening portion from both ends of the fastening portion to a middle part of the fastening portion.

According to the rotor, the shaft can be easily formed with the fastening portion by a simple method such as grinding. Note that, the step may be formed between the fastening portion and the at least one other portion of the shaft. According to this configuration, the material corresponding to the interference can be prevented more reliably from expanding in the axial direction.

It will be appreciated that the present invention is not limited to the configurations described above, but any and all modifications, variations or equivalents, which may occur to those who are skilled in the art, should be considered to fall within the scope of the present invention.

What is claimed is:

1. A rotor for an electric rotating machine, which includes a shaft and a core which is fastened to an outer periphery surface of the shaft by shrink fitting, wherein
the shaft includes a fastening portion to which the core is fastened, and
a diameter of the fastening portion is smaller than a diameter of at least one other portion of the shaft.

2. The rotor according to claim 1, wherein
the shaft includes a step between the fastening portion and the at least one other portion.

3. The rotor according to claim 2, wherein
the diameter of the fastening portion is constant in the axial direction of the fastening portion.

4. The rotor according to claim 2, wherein
the diameter of the fastening portion gradually decreases in the axial direction of the fastening portion from a middle part of the fastening portion to both ends of the fastening portion.

5. The rotor according to claim 1, wherein
the diameter of the fastening portion gradually decreases in the axial direction of the fastening portion from both ends of the fastening portion to a middle part of the fastening portion.
